(19) United States
(12) Patent Application Publication
(10) Pub. No.: US 2007/0087736 A1
(43) Pub. Date: Apr. 19, 2007

(54) System and method for locating a misplaced cellular telephone

(76) Inventors: R. Lee Wilson, Greenwich, CT (US); Robert L. Wilson III, Greenwich, CT (US)

Correspondence Address: EDWARDS & ANGELL, LLP, P.O. BOX 55874, BOSTON, MA, 02205, US

(21) Appl. No.: 11/253,955

(22) Filed: Oct. 19, 2005

(51) Int. Cl. H04M 3/00

(52) U.S. Cl. 455/418; 455/419

(57) ABSTRACT

A system and method for locating a misplaced cellular telephone including sending a signal to the misplaced cellular telephone. The signal directs the misplaced cellular telephone to transition from an inaudible mode to a loud ring mode and, in turn, ring to enable the ready location of the misplaced cellular telephone. In a further aspect, the signal directs the misplaced cellular telephone to ring continuously at maximum volume. Preferably, the method includes generating the signal from a telephone, a remote and/or a computer connected to the Internet.

### BACKGROUND OF THE INVENTION

1. Field of the Invention

The subject disclosure relates to methods and systems for locating a cellular telephone and, more particularly, transitioning a cell phone from vibrate mode to ring mode in order to more easily locate the cell phone.

2. Background of the Related Art

In the modern era, cell phones have become ubiquitous. The ever present ringing and talking has become intrusive in many scenarios. Even further, many places have guidelines prohibiting cell phone usage. For example, theaters, classes, airplanes, hospitals, business meetings, golf tournaments and the like are all events at which cell phone usage is prohibited. As a result, many cell phones are set to vibrate rather than ring when receiving an incoming call.

Unlike traditional phones that plug into a wall, cell phones are easily misplaced. The small size and weight allows cell phones to be left in jackets that are hanging in a closet, dropped down between the sofa cushions, placed under a stack of other objects and lost in such various places which missing items gravitate into. Often, a simple call to one's cell phone will allow following the ring tone to locate the cell phone. However, when the cell phone is set to vibrate, the vibration is typically not helpful enough to allow locating the cell phone. In view of this and other shortcomings, a system and method for locating misplaced cell phones set to vibrate is needed.

### SUMMARY OF THE INVENTION

It is an object of the subject technology to allow for locating a lost cell phone by transitioning to an indicator mode while utilizing existing procedures, hardware and software to the extent possible.

The present disclosure is directed to a method for locating a misplaced cellular telephone including the step of sending a signal to the misplaced cellular telephone, wherein the signal directs the misplaced cellular telephone to transition from a set mode to a ring mode and, in turn, ring to enable the ready location of the misplaced cellular telephone. In a further aspect, the signal directs the misplaced cellular telephone to ring continuously at maximum volume. Preferably, the method includes generating the signal from a telephone, a remote or a computer.

Another embodiment of the present disclosure includes locating a misplaced cellular telephone by i) receiving a request to find a cellular telephone, ii) requesting personal identification data related to verification of the request, iii) sending transition data to the cellular telephone for switching to an indicator mode such that said indicator mode is activated to enable the ready location of the misplaced cellular telephone and iv) generating a fee for payment by a user of the cellular telephone based upon steps i)-iii). The fee may be based on usage or a set montly amount.

Still another embodiment of the present disclosure is a server for facilitating locating a misplaced cell phone. The server includes a memory storing an instruction set and a processor for running the instruction set. The processor is in communication with the memory and the misplaced cell phone, and operative to verify a request to communicate with the misplaced cell phone and communicate with the misplaced cell phone to direct the misplaced cell phone to switch to ring mode.

And yet another embodiment of the present invention is a package having a cellular telephone and a remote being capable of sending a signal to the cellular telephone, wherein the signal directs the cellular telephone to ring.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings as follows.

FIG. 1 is a somewhat schematic diagram showing an environment for using cell phones in accordance with the subject disclosure.

FIG. 2 is a somewhat schematic diagram of a service provider for practicing the disclosed methodology.

FIG. 3 is a flow diagram of a process for locating a cell phone set to vibrate by using another telephone in accordance with the subject disclosure.

FIG. 4 is a flow diagram of a process for locating a cell phone set to vibrate by using the Internet in accordance with the subject disclosure.

### DETAILED DESCRIPTION OF PREFERRED EMBODIMENTS

The present invention overcomes many of the prior art problems associated with locating misplaced cell phones. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

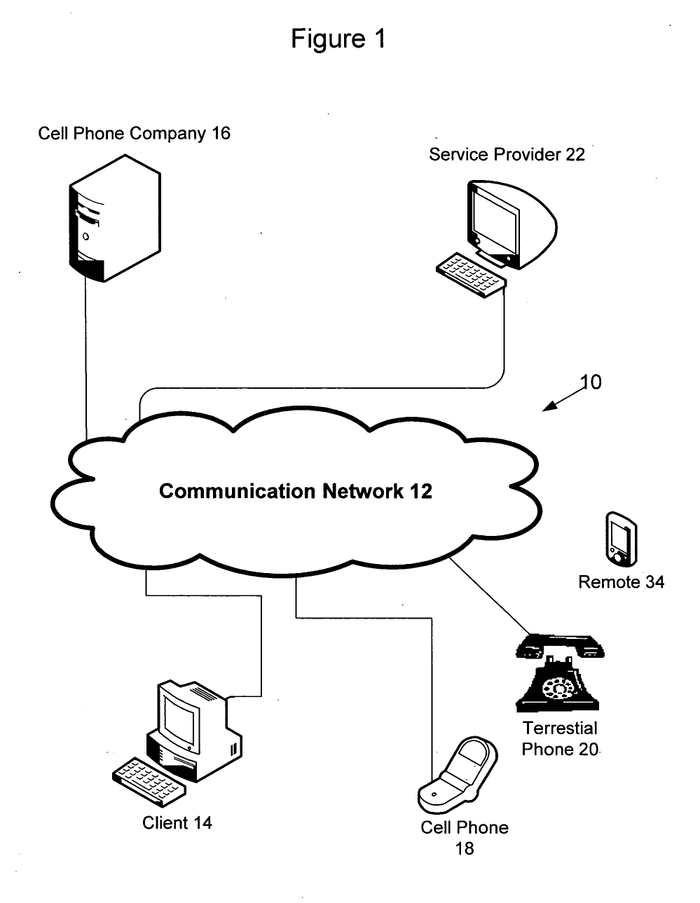

Referring now to the FIG. 1, there is shown a somewhat schematic diagram of an environment 10 in which the subject methodology of the present disclosure can be implemented. The following discussion describes the structure of such an environment 10 but further discussion of the technology, applications program and data modules that embody the methodology of the present invention is described elsewhere herein. Although a simplified diagram is illustrated in FIG. 1 such illustration shall not be construed as limiting the present invention to the illustrated embodiment.

The environment 10 includes a distributed commmunication network 12 having any number of network systems well known to those skilled in the art. For example, distributed commmunication network 12 may be any combination of local area networks (LAN), wide area networks (WAN), cell phone towers, satellites, traditional phone exchanges, a coaxial cable network and the like which may be publicly or privately held as is well known. In a preferred embodiment, the distributed communication network 12 is the Internet in combination with cell phone towers. The environment 10 also includes a plurality of servers (not shown) which communicate with clients 14 via the distributed commmunication network 12 over communication channels, whether wired or wireless, as is well known to those of ordinary skill in the pertinent art. For simplicity, one personal computer or client 14 is shown. Servers execute software code, host Web sites and house multiple databases for the proper operation of the various business processes needed by the subject methodology and to support the other necessary services envisioned in the environment 10. It will be recognized that the hardware of clients 14 and servers would often be interchangeable. However, the clients 14 for end user access can be relatively less powerful and, therefore, less expensive computers such as desktop computers, laptop computers, personal digital assistants, cellular telephones and the like. Preferably, the client 14 has a display and an input device(s) as would be appreciated by those of ordinary skill in the pertinent art. Clients 14 typically provide users with the ability to store, process and access data as well as accomplish activity as described as part of the subject methodology.

Still referring to FIG. 1, a cell phone company 16 is in communication with the distributed commmunication network 12 and operates a plurality of antenna towers (not shown) to allow communication with a cell phone 18. The cell phone 18 communicates through wireless technology as is well known and, for simplicity, only one of a plurality is shown. A service provider 22 is also connected to the environment 10 such that the service provider can communicate with the distributed commmunication network 12, the client 14, the cell phone company 16 and the cell phone 18 via cell towers. Although discussed herein largely as a separate entity, the service provider 22 could be fully incorporated into the cell phone company 16 rather than a stand alone entity. Traditional land-line phones, for simplicity represented as a single phone 20, are also connected to the environment 10 and able to communicate with the various components.

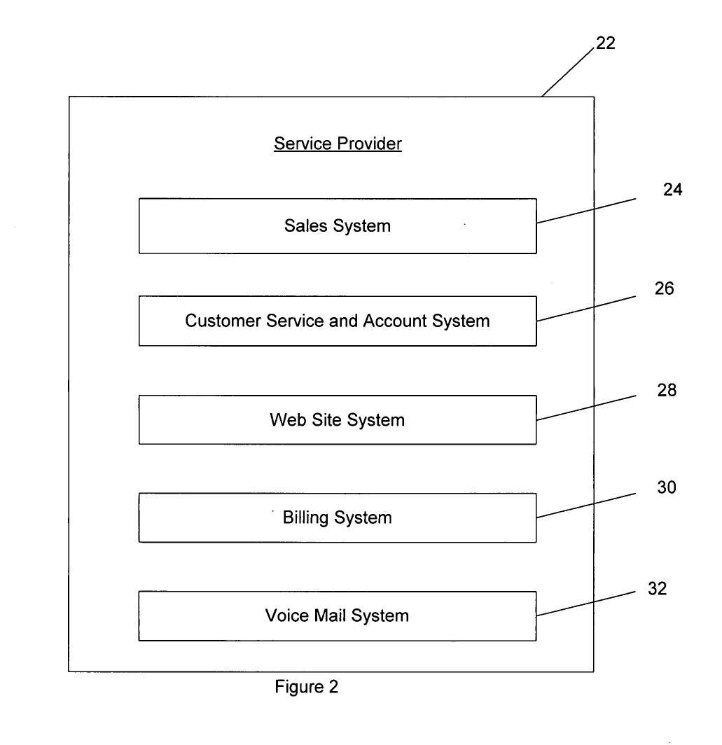

Referring now to FIG. 2, a somewhat schematic diagram of a service provider 22 is illustrated. The service provider 22 has several business components for accomplishing the tasks associated with the subject methodology and otherwise. In particular, a sales system 24 creates a marketing campaign for the services provided. An important component of the marketing campaign is branding the products and services. The sales system 24 also is responsible for integrating the products and services into or with the marketing campaigns associated with the cell phone company 16. Such integration includes programming the technology of the cell phone company 16 to track and update customer records and bill customers for services as provided.

Another business component of the service provider 22 is a customer service and account system 26. The customer service and account system 26 is responsible for recognizing use of the services provided and insuring that such usage is properly recorded in the customer records. As many customers may access the services by the Internet, the customer service and account system 26 creates and modifies the Web site as hosted by the Web site system 28. The Web site allows interaction and participation in the subject processes by a plurality of users as described in more detail herein. It is envisioned that the Web site provides for administration and security maintenance. Therefore, although each user (e.g., users looking for cell phones, the cell phone company 16 and employees of the service provider 22) of the subject invention has access to a user interfac, each user's access is controlled. The user interface specifies which aspects can be accessed, and at what level in order to maintain compliance with technical electronic data interchange standards, system integrity and confidentiality restraints. Such limitations of functionality are well known to those skilled in the art and therefore not further described herein. Additionally, the Web site provides responses to frequently asked questions (FAQ), training routines and access to various other supporting technology. The service provider 22 also has a billing system 30 for tracking fees, generating invoices and administering collection. Still further, the service provider 22 has a voice mail system 32 for executing various steps needed to perform the subject methodology. It is envisioned that the voice mail system 32 also provides for administration and security maintenance.

The flow charts herein illustrate the structure or the logic of the present invention as embodied in computer program software for execution on a computer, digital processor or microprocessor such as a client 14 and/or server in communication with cell phone 18. Those skilled in the art will appreciate that the flow charts illustrate the structures of the computer program code elements, including logic circuits on an integrated circuit, that function according to the present invention. As such, the present invention is practiced in its essential embodiment(s) by a machine component that renders the program code elements in a form that instructs a digital processing apparatus (e.g., computer) to perform a sequence of function step(s) corresponding to those shown in the flow diagrams.

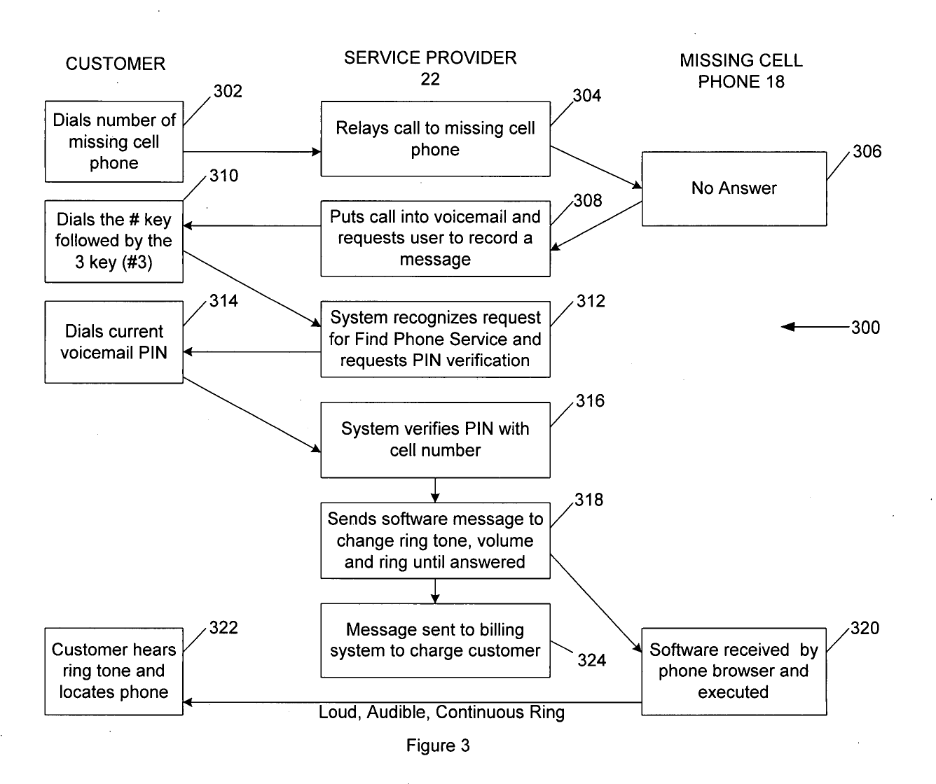

Referring now to FIG. 3, there is illustrated a flowchart 300 depicting a process for locating a misplaced cell phone that has been left in vibrate mode in accordance with an embodiment of the present invention. In brief overview, for example, the process allows an authorized user of a misplaced cell phone 18 to use another telephone 20, cellular or otherwise, to remotely access the settings of the cell phone 18 and transition one or more settings to a desired state or indicator mode to allow locating the cell phone 18. The flowchart 300 is organized such that the actions under the heading of “CUSTOMER” are performed by the authorized user, the actions under the heading of “SERVICE PROVIDER 22” are performed by the service provider 22 and the actions under the heading of “MISSING CELL PHONE 18” are performed by the misplaced cell phone 18.

At step 302, the user places a call to the misplaced cell phone 18 in a customary manner. It is envisioned that in order to have the service in this embodiment, the user has previously contracted with the service provider 22 and, as such, calls are routed through the service provider 22. Accordingly, at step 304, the call is relayed by the service provider 22 to the cell phone 18. At step 306, the call remains unanswered and control passes back to the service provider 22 such that voicemail is engaged. The service provider 22, cell phone company 16 or like entity may actually provide the voicemail system. As the user listens to the voicemail request to leave a message at step 310, a code can be entered to prompt usage of the phone locating service. For example, the code could be pressing “#” and “F”. Upon entry of the code, transfer of the call passes back to the service provider 22 at step 312.

At step 312, the service provider 22 recognizes the request to locate the cell phone and requests authorization data from the user. Preferably, the authorization data is a personal identification number (PIN) selected by the user or otherwise assigned. When using a PIN set to access voice mail, the user does not need to remember additional information and the required programming is simplified as well. At step 314, the user responds by keying in their PIN for subsequent verification by the service provider 22 at step 316. Upon successful verification of the PIN for the specific cell phone 18, the process 300 proceeds to step 318. If the PIN verification process is unsuccessful, the process 300 may terminate or provide multiple requests for a correct PIN. At step 318, the service provider 22 transmits a message to the cell phone 18, through a browser of the cell phone 18. At step 320, the message directs the cell phone 18 to reset the ring tone from vibrate to ring, maximizes the volume and causes uninterrupted ringing until answered. As a result, the user has an audible signal to help located the cell phone 18 as referred to at step 322.

Alternatively, if the cell phone 18 is answered by someone other than the user, the user is able to request assistance in return of the cell phone 18. In another embodiment, the cell phone 18 has a light that is activated to blink or remain on as a visual beacon as well. In still another embodiment, vibrate is turned on as well. In still a further embodiment, the cell phone 18 is directed to emit a continous tone or particular song until answered. Further, the cell phone 18 may simply be set to a soft ring tone that needs amplification to maximum. Such transition of the capabilities of the cell phone 18 to be more conspicuous and other variations are considered within the scope of an indicator mode as would be apparent upon review of the subject application.

Still referring to FIG. 3, upon completion of providing the service to the user, the service provider 22 generates a message for the billing system 30 at step 324. Upon receipt of the message, the billing system 30 generates an invoice to be paid by the user. The invoice may take the form of a predetermined periodic charge sent directly to the user or an additional per-use charge added to the invoice generated by the cell phone company 16. The contractual fee may also be a single payment upon subscribing to a service plan and other variations as would be apparent upon review of the subject application.

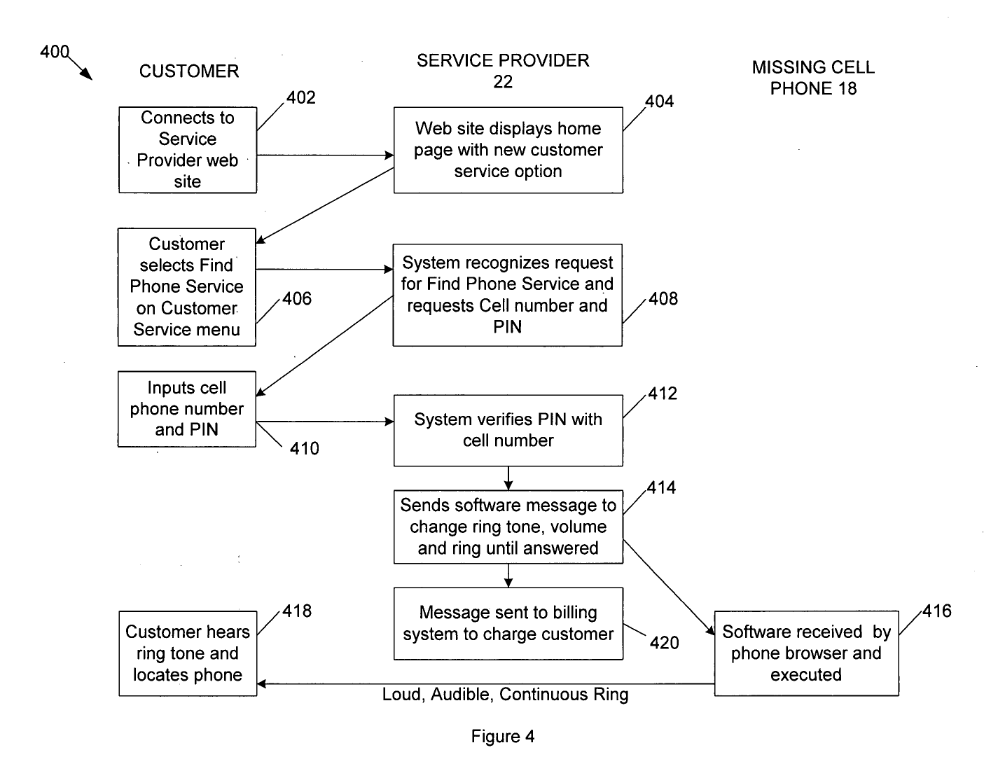

Referring now to FIG. 4, there is illustrated a flowchart 400 depicting another process for locating a misplaced cell phone that has been left in vibrate mode in accordance with an embodiment of the present invention. In brief overview, for example, the process allows an authorized user of a misplaced cell phone 18 to use a client 14 to remotely access the settings of the cell phone 18 and transition one or more settings to a desired state to allow locating the cell phone 18. The flowchart 400 is organized similarly to flowchart 300.

At step 402, the user uses the client 14 to access the Web site hosted by the Web site system 28 of the service provider 22. At step 404, the Web site provides a plurality of options for the user. One of the options is utilizing the process described herein. At step 406, the user selects the find lost cell phone service and control passes to step 408. At step 408, the service provider 22 recognizes the request and prompts the user for authorization data (e.g., the cell phone number and PIN). At step 410, the user responds by providing the requested authorization data for subsequent verification by the service provider 22 at step 412. Upon successful verification of the authorization data for the specific cell phone 18, the process 400 proceeds to step 414.

At step 414, the service provider 22 transmits a message to the cell phone 18 through a browser of the cell phone 18. The message directs the cell phone 18 to reset the ring tone, maximize volume and ring continuously until answered. At step 416, the cell phone 18 receives the message and begins ringing. As a result, the user has an audible signal to help locate the cell phone 18. At step 418, the user locates the cell phone 18 and stops the ringing by answering the call. In the event the phone is anwered by someone other than the user, a prerecorded message with instructions is played. The instructions may provide a contact telephone number, a Web site address, offer a reward and the like for returning the cell phone 18. Upon completion of providing the service to the user, the service provider 22 generates a message for the billing system 30 at step 420. Upon receipt of the message, the billing system 30 generates an invoice to be paid by the user.

Referring again to FIG. 1, the environment 10 also includes a remote 34 associated with the cell phone 18. The remote 34 is separate from the cell phone 18. Preferably, the remote 34 is small enough to be carried on a key chain. When activated, the remote 34 sends a signal to the cell phone 18 that transitions the cell phone 18 to ring continously at maximum volume and/or other indicia to facilitate locating the cell phone 18. In one embodiment, the remote 34 is sold as a set with the cell phone 18. Alternatively, the remote 34 is purchased separately and configured to a desired cell phone and may be subsequently reconfigured for another phone. In still another embodiment, the remote 34 is programmable to selectively activate a plurality of cell phones.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., entities, components, interfaces, computers, servers and the like) shown as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

What is claimed is:

1. A method for locating a misplaced cellular telephone comprising the step of sending a signal to the misplaced cellular telephone, wherein the signal directs the misplaced cellular telephone to transition from a set mode to a ring mode and, in turn, ring, to enable the ready location of the misplaced cellular telephone.

2. A method as recited in claim 1, wherein the signal further directs the misplaced cellular telephone to ring continuously at maximum volume.

3. A method as recited in claim 1, further comprising the step of generating the signal from a telephone.

4. A method as recited in claim 1, further comprising the step of generating the signal from a remote.

5. A method as recited in claim 1, further comprising the step of generating the signal from a computer via the Internet and a cell phone network.

6. A method of locating a misplaced cellular telephone comprising the steps of:
i) receiving a request to locate a cellular telephone;
ii) requesting personal identification data related to verification of the request;
iii) sending transition data to the cellular telephone for switching from a set mode to an indicator mode such that said indicator mode is activated to enable ready location of the misplaced cellular telephone; and
iv) generating a fee for payment by a user of the cellular telephone based upon steps i)-iii).

7. A method as recited in claim 6, wherein the fee is based on usage.

8. A method as recited in claim 6, wherein the fee is a predetermined periodic fee.

9. A method as recited in claim 6, wherein the fee is a single payment.

10. A method as recited in claim 6, wherein the indicator mode is maximizing a volume of a ringer of the cellular telephone.

11. A server for facilitating locating a misplaced cell phone comprising:
(a) a memory storing an instruction set; and
(b) a processor for running the instruction set, the processor being in communication with the memory and the misplaced cell phone, wherein the processor is operative to:
(i) verify a request to communicate with the misplaced cell phone; and
(ii) communicate with the misplaced cell phone to direct the misplaced cell phone to switch to ring mode.

12. A package comprising:
a cellular telephone; and
a remote signaling device being capable of sending a signal to the cellular telephone, wherein the signal directs the cellular telephone to ring.

13. A package as recited in claim 12, wherein the signal directs the cellular telephone to transition to ring mode.

14. A method of locating a misplaced cellular telephone, comprising the steps of:
a) sending a signal to the misplaced cellular telephone; and
b) causing the misplaced cellular telephone to transition from a first inaudible response mode to a second audible response mode, upon receipt of the signal to enable ready location of the cellular telephone.

15. A method of locating a misplaced cellular telephone set in an inaudible response mode, comprising the steps of:
a) sending a signal from a remote location to the misplaced cellular telephone; and
b) causing the misplaced cellular telephone to transition from the inaudible response mode to an audible response mode, upon receipt of the signal signal to enable ready location of the cellular telephone.

16. A server for facilitating locating cell phones, wherein the server communicates with phones and clients via a network, and wherein the server comprises:
(a) a memory storing an instruction set and user data related to a plurality of cell phones; and
(b) a processor for running the instruction set, the processor being in communication with the memory and the network, wherein the processor is operative to:
(i) receive messages from the phones and the clients requesting a service for locating a misplaced cell phone;
(ii) request verification data associated with the misplaced cell phone;
(iii) authenticate the verification data based on comparison with the user data;
(iv) transmit a signal to the misplaced cell phone to transition from a first inaudible response mode to a second audible response mode and ring.

17. A server as recited in claim 16, wherein the messages include a cellular telephone number.

18. A server as recited in claim 16, wherein the verfication data is a personal identification number.

19. A server as recited in claim 16, wherein the personal identification number is also associated with a voice mail account of the user data.
